(19) United States
(12) Patent Application Publication
(10) Pub. No.: US 2014/0085560 A1
(43) Pub. Date: Mar. 27, 2014

(54) DISPLAY DEVICE

(71) Applicant: InnoLux Corporation, Miao-Li County (TW)

(72) Inventors: Li-Wei SUNG, Miao-Li County (TW); Tsung-Lin TSAI, Miao-Li County (TW); An-Chang WANG, Miao-Li County (TW); Chung-Le CHEN, Miao-Li County (TW)

(73) Assignee: InnoLux Corporation, Miao-Li County (TW)

(21) Appl. No.: 14/017,407

(22) Filed: Sep. 4, 2013

(30) Foreign Application Priority Data
Sep. 21, 2012 (TW) 101134631

(51) Int. Cl. G02F 1/133; G02F 1/1368

(52) U.S. Cl. CPC G02F 1/13306; G02F 1/1368
USPC 349/43

(57) ABSTRACT

A display panel of a display device has an active area and an edge area outside of the active area and includes a plurality of pixel electrodes, a plurality of scan lines, and a scan driver. The pixel electrodes and the scan lines are formed at the active area, and the scan driver is formed at the edge area. The scan driver includes a plurality of shift registers, and each of the shift registers has an input unit configured to receive a turn on signal, and a control unit configured to control noise, wherein the input unit or the control unit are dual gate transistors.

### CROSS REFERENCE TO RELATED APPLICATIONS

This application claims priority of Taiwan Patent Application No. 101134631, filed on Sep. 21, 2012, the entirety of which is incorporated by reference herein.

### BACKGROUND OF THE INVENTION

1. Field of the Invention

The present invention relates to a display device, and in particular, relates to a display device in which a scan driver of a display panel thereof has at least one dual gate transistor.

2. Description of the Related Art

In recent years, with great advances in fabrication techniques, portable electronic devices and flat panel displays have been vigorously developed. Among the flat panel displays, a liquid crystal display (hereinafter “LCD”) has become a mainstream utilized display device because it has the advantages of being thin in size, and light in weight, and consumes less power, and does not emit radiation.

To reduce the fabrication cost of the LCD, some manufacturers have directly fabricated a plurality of amorphous silicon (a-Si) shift registers on a glass substrate via an amorphous silicon (a-Si) process.

However, the stability of the output signals (i.e. the scan signal) of the circuits in the conventional a-Si shift registers is not good, and it is easily influenced by the coupling of the external clock signals to produce large noises (such as coupling noise), thereby causing wrong logic outputs.

### BRIEF SUMMARY OF THE INVENTION

In this regard, the present invention is directed to a shift register apparatus with both characteristics of restraining coupling noise and reducing manufacturing costs.

According to one embodiment of the invention, the display device includes a display panel having an active area and an edge area outside of the active area, and the display panel comprises a plurality of pixel electrodes, a plurality of scan lines and a scan driver. The pixel electrodes and the scan lines are disposed in the active area. The scan driver is disposed in the edge area and includes a plurality of shift registers, wherein each of the shift registers receives a clock signal from an external circuit. An output signal from a pre-stage shift register is an input signal of the other shift registers. Each of the shift registers includes a first transistor, a second transistor, a third transistor, a fourth transistor, a fifth transistor, a sixth transistor and a seventh transistor.

A first electrode of the first transistor is electrically connected to the clock signal, and a second electrode of the first transistor is electrically connected to the scan lines. The second transistor is a dual gate transistor, and a control electrode of the second transistor comprises a lower gate electrode and an upper gate electrode, wherein the lower gate electrode of the second transistor is electrically connected to the output signal from the pre-stage shift register, and the upper gate electrode of the second transistor is electrically connected to the lower gate electrode of the second transistor, and a first electrode of the second transistor is electrically connected to the output signal from the pre-stage shift register, and a second electrode of the second transistor is electrically connected to a control electrode of the first transistor. A first electrode of the third transistor is electrically connected to the control electrode of the first transistor, and a second electrode of the third transistor is electrically connected to a reference voltage. A first electrode of the fourth transistor is electrically connected to a control electrode of the third transistor, and a second electrode of the fourth transistor is electrically connected to the reference voltage.

In one embodiment, the fourth transistor is a dual gate transistor, and a control electrode of the fourth transistor comprises a lower gate electrode and an upper gate electrode, wherein the lower gate electrode of the fourth transistor is electrically connected to the second electrode of the second transistor, and the upper gate electrode of the fourth transistor is electrically connected to the reference voltage or to the lower gate electrode of the fourth transistor.

In one embodiment, a control electrode of the fifth transistor is electrically connected to an output signal of a next-stage shift register, and a first electrode of the fifth transistor is electrically connected to the second electrode of the first transistor, and a second electrode of the fifth transistor is electrically connected to the reference voltage. A control electrode of the sixth transistor is electrically connected to the output signal of the next-stage shift register, and a first electrode of the sixth transistor is electrically connected to the control electrode of the first transistor, and a second electrode of the sixth transistor is electrically connected to the reference voltage. A control electrode and a first electrode of the seventh transistor are electrically connected to the clock signal, and a second electrode of the seventh transistor is electrically connected to the control electrode of the third transistor.

In one embodiment, the material of the upper gate electrode of the second or the fourth transistor comprises ITO, IZO, Al, Cu or Mo.

In one embodiment, the display panel further comprises a substrate, and the lower gate electrode of the second transistor is formed on the substrate, and the second transistor further comprises a first dielectric layer, a semiconductor layer and a second dielectric layer. The first dielectric layer covers the lower gate electrode of the second transistor and the substrate. The semiconductor layer is formed on the first dielectric layer, wherein the first and second electrodes of the second transistor are located at two opposite sides of the semiconductor layer. The second dielectric layer covers the first and second electrodes of the second transistor and the semiconductor layer, wherein the upper gate electrode of the second transistor is formed on the second dielectric layer corresponding to the semiconductor layer.

In one embodiment, a front channel is defined at one side of the semiconductor layer adjacent to the lower gate electrode of the second transistor, and the width of the upper gate electrode of the second transistor is larger than or equals to the length of the front channel. Moreover, a back channel is defined at one side of the semiconductor layer adjacent to the upper gate electrode of the second transistor, and the width of the upper gate electrode of the second transistor is larger than or equals to the length of the back channel.

In one embodiment, the thickness of the second dielectric layers is in a range from 2000 Å to 30000 Å.

In one embodiment, the material of the semiconductor layers of the second transistor comprises a-Si, LTPS, or IGZO.

In one embodiment, the semiconductor layer comprises a stop etching layer.

Through the circuit layout of the shift register, image noise produced by the display device using the shift register can be restrained. Thus, the drawbacks of prior arts are overcome.

### BRIEF DESCRIPTION OF THE DRAWINGS

The present invention is more fully understood by reading the subsequent detailed description and examples with references made to the accompanying drawings, wherein:

FIG. 1 is a schematic view of a liquid crystal display device according to one or more embodiments of the present invention;

FIG. 2 is a circuit diagram of a shift register according to the first embodiment of the present invention;

FIG. 3A is a top view of a second transistor according to the first embodiment of the present invention;

FIG. 3B a cross-sectional view taken along line A-A′ in FIG. 3A;

FIG. 4A is a top view of a fourth transistor according to the first embodiment of the present invention;

FIG. 4B is a cross-sectional view taken along line B-B′ of FIG. 4A;

FIG. 5 is a circuit diagram of a shift register according to the second embodiment of the present invention;

FIG. 6A is a diagram of an output waveform of the circuit layout shown in FIG. 5, wherein the second transistors T2 and T2a and fourth transistor T4 are replaced by single gate transistors;

FIG. 6B is a diagram of an output waveform of the circuit layout shown in FIG. 5, wherein the fourth transistor T4 is replaced by a single gate transistor; and

FIG. 6C is a diagram of an output waveform of the circuit layout shown in FIG. 5.

### DETAILED DESCRIPTION OF THE INVENTION

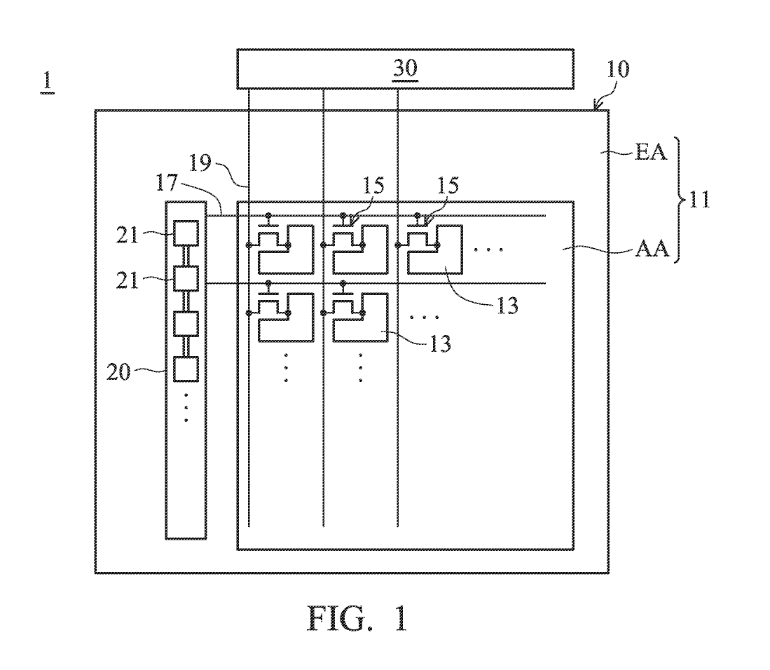

Several exemplary embodiments of the application are described with reference to FIGS. 1 through 6. It is to be understood that the following disclosure provides various different embodiments as examples for implementing different features of the application. This description is made for the purpose of illustrating the general principles of the invention and should not be taken in a limiting sense.

Referring to FIG. 1, a display 1 of one or more embodiments of the invention includes a display panel 10. In one unlimited embodiment, the display panel 10 is a liquid crystal display panel, and the display panel 10 also includes a backlight module (not shown in figures) which is configured to provide backlight for the display panel 10. The display panel 10 includes a substrate 11, wherein the substrate 11 has an active area AA and an edge area EA outside of the active area AA. A plurality of pixel electrodes 13, a plurality of thin film transistors (TFTs) 15, a plurality of scan lines 17 and a plurality of data lines 19 are formed at the active area AA of the substrate 11. A scan driver 20 is formed at the edge area EA of the substrate 11. The scan driver 20 is electrically connected to the scan lines 17 and outputs signals to each of the TFTs 15 via the scan lines 17 so as to control ON-OFF switching of the TFTs 15. A data driver 30 is electrically connected to the data lines 19 and outputs signals to each of the TFTs 15 via the data lines 19 so as to provide driving voltages for the pixel electrodes 13.

As shown in FIG. 1, the scan driver 20 includes of a plurality of shift registers 21, and each of shift registers 21 receives a clock signal from an external circuit. In addition, each of the shift registers 21 receives output signals from a pre-stage shift register 21. For example, the N^{th} shift register receives an output signal from the (N−2)^{th} shift register and so on. Since the interconnections of the shift registers are within the knowledge of one skilled in the art, further elaboration will not be presented hereinafter.

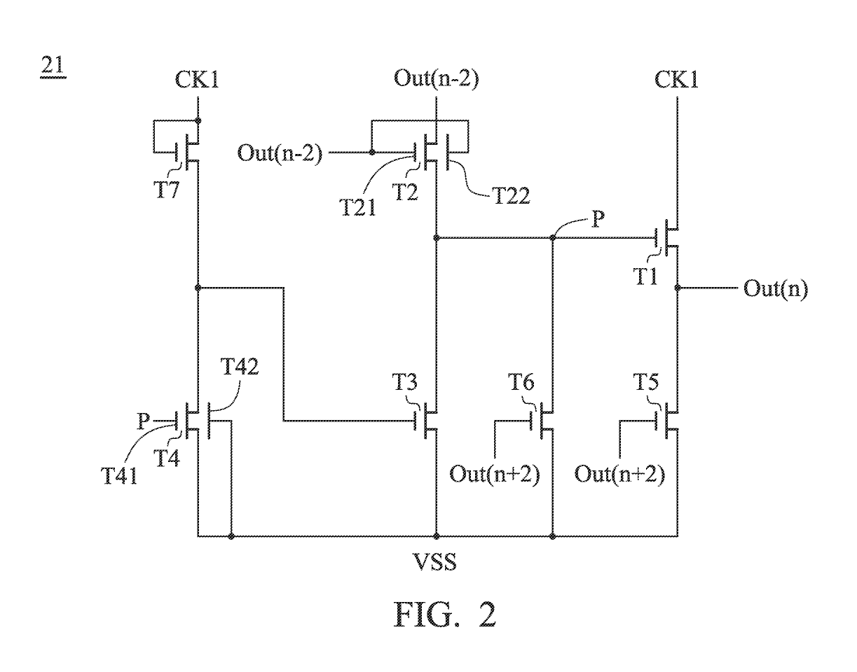

Referring to FIG. 2, the structure of the each single shift register 21 is further described. It is appreciated that while each of the shift registers in the embodiment has an identical structure, it should not be limited thereto. The structure of each of the shift registers may be varied.

Each of the shift registers 21 includes a first transistor T1, a second transistor T2, a third transistor T3 and a fourth transistor T4. In the embodiment, each of the transistors T1-T4 has a control electrode, a first electrode and a second electrode. For example, the first electrode is a source, and the second electrode is a drain, but it should not be limited thereto.

In FIG. 2, Out(n−2) represents an output signal of the (N−2)^{th} shift register, i.e. a signal outputted from the (N−2)^{th} shift register. Out(n+2) represents an output signal of the (N+2)^{th} shift register, i.e. a signal outputted from the (N+2)^{th} shift register. CK1 represents a clock signal, and VSS represents a reference voltage.

The first electrode of the first transistor T1 is electrically connected to the clock signal, and the second electrode of first transistor T1 is electrically connected to the scan lines 17 (FIG. 1). The second transistor T2 is a dual gate transistor including lower and upper gate electrodes T21 and T22 serving as control electrodes thereof. The lower gate electrode T21 of the second transistor T2 receives the output signal Out(n−2) from the pre-stage shift register, and the upper gate electrode T22 is electrically connected to the lower gate electrode T21 of the second transistor T2. Moreover, the first electrode of the second transistor T2 receives the output signal Out(n−2) from the pre-stage shift register, and the second electrode of the second transistor T2 is electrically connected to the control electrode of the first transistor T1.

The first electrode of the third transistor T3 is electrically connected to the control electrode of the first transistor T1, and the second electrode of the third transistor T3 is electrically connected to a reference voltage VSS. The fourth transistor T4 is a dual gate transistor including lower and upper gate electrodes T41 and T42 serving as control electrodes thereof. The lower gate electrode T41 of the fourth transistor T4 is electrically connected to the second electrode of the second transistor T2, and the upper gate electrode T42 of the fourth transistor T4 is electrically connected to the reference voltage VSS. The control electrode of the fourth transistor T4 is electrically connected to the second electrode of the second transistor T2. The first electrode of the fourth transistor T4 is electrically connected to the control electrode of the third transistor T3, and the second electrode of the fourth transistor T4 is electrically connected to a reference voltage VSS.

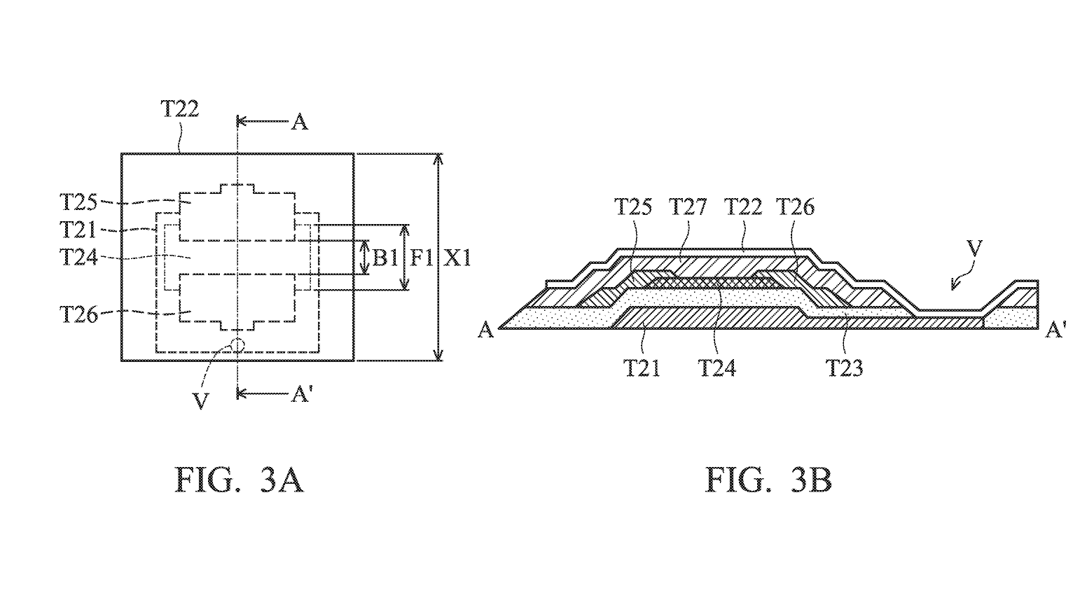

Referring to FIGS. 3A and 3B, a top view of the second transistor T2 of one of the embodiments is shown in FIG. 3A, and the cross-sectional view taken along line A-A′ in FIG. 3A is shown in FIG. 3B. The second transistor T2 includes a lower gate electrode T21, a first dielectric layer T23, a semiconductor layer T24, a first electrode T25, a second electrode T26, a second dielectric layer T27 and an upper gate electrode T22.

The lower gate electrode T21 is formed on the substrate 11 (FIG. 1) of the display panel 10, and the first dielectric layer T23 covers the lower gate electrode T21 and the substrate 11. The semiconductor layer T24 is formed on the first dielectric layer T23, wherein the semiconductor layer is made of a-Si (amorphous silicon), LTPS (low temperature polysilicon), or IGZO (amorphous Indium Gallium Zinc Oxide). Alternatively, the semiconductor layer may include a stop etching layer. The first electrode T25 and the second electrode T26 are disposed at two opposite sides of the semiconductor layer T24. The second dielectric layer T27 covers the first and second electrodes T25 and T26 and the semiconductor layer T24, wherein the upper gate electrode T22 is formed on the second dielectric layer T27 relative to the semiconductor layer T24. It is noted that, a through hole V is formed at a position away from the second electrode T26 and passes through the first and second dielectric layers T23 and T27, wherein the upper gate electrode T22 is connected to the lower gate electrode T21 via the through hole V.

Note that one side of the semiconductor layer T24 adjacent to the lower gate electrode T21 has a front channel F1, and one side of the semiconductor layer T24 adjacent to the upper gate electrode T22 has a back channel B1, wherein the width X1 of the upper gate electrode T22 of the second transistor T2 is larger than or equal to the length of the front channel F1 (i.e. the front channel F1 is completely covered by the upper gate electrode T22), and the width of the upper gate electrode T22 of the second transistor T2 is larger than or equal to the length of the back channel B1 (i.e. the back channel B1 is completely covered by the upper gate electrode T22) so as to accurately control ON-OFF switching of the front and back channels F1 and B1.

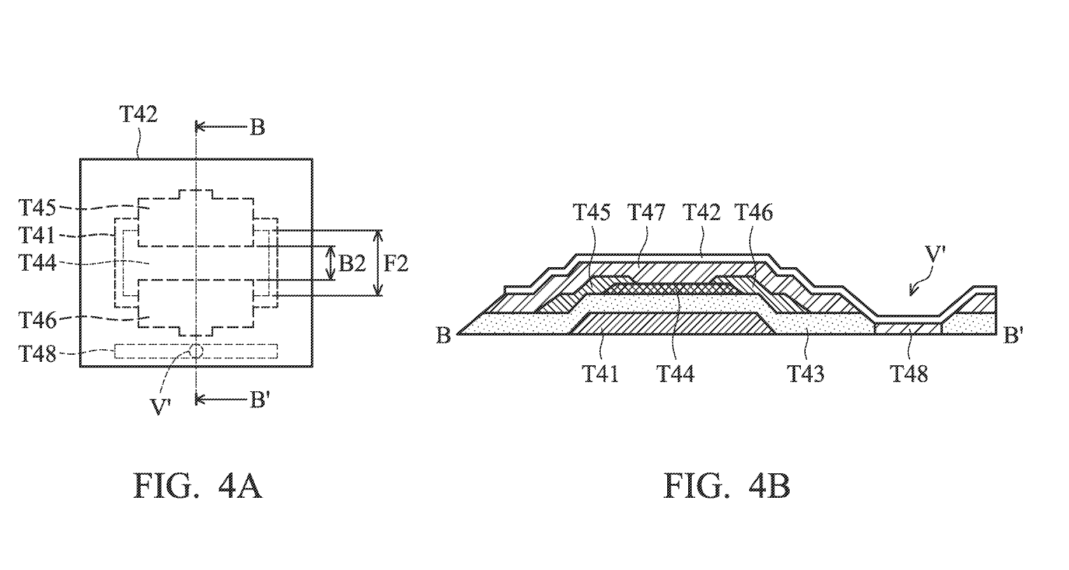

Referring to FIGS. 4A and 4B, a top view of the fourth transistor T4 of one of the embodiments is shown in FIG. 4A, and the cross-sectional view taken along line B-B′ of FIG. 4A is shown in FIG. 4B. The fourth transistor T4 includes a lower gate electrode T41, a first dielectric layer T43, a semiconductor layer T44, a first electrode T45, a second electrode T46, a second dielectric layer T47 and an upper gate electrode T42.

The lower gate electrode T41 is formed on the substrate 11 (FIG. 1) of the display panel 10, and the first dielectric layer T43 covers the lower gate electrode T41 and the substrate 11. The semiconductor layer T44 is formed on the first dielectric layer T43, wherein the semiconductor layer is made of a-Si (amorphous silicon), LTPS (low temperature polysilicon), or IGZO (amorphous Indium Gallium Zinc Oxide). Alternatively, the semiconductor layer may include a stop etching layer. The first electrode T45 and the second electrode T46 are disposed at two opposite sides of the semiconductor layer T44. The second dielectric layer T47 covers the first and second electrodes T45 and T46 and the semiconductor layer T44, wherein the upper gate electrode T42 is formed on the second dielectric layer T47 relative to the semiconductor layer T44. It is noted that, a through hole V′ is formed at a position away from the second electrode T46 and passes through the first and second dielectric layers T43 and T47, wherein the upper gate electrode T42 is connected to the conductive layer T48 via the through hole V to electrically connect to a reference voltage VSS.

Note that one side of the semiconductor layer T44 adjacent to the lower gate electrode T41 has a front channel F2, and one side of the semiconductor layer T44 adjacent to the upper gate electrode T42 has a back channel B2, wherein the width of the upper gate electrode T42 of the fourth transistor T4 is larger than or equal to the width of the front channel F 1, and the width of the upper gate electrode T42 of the fourth transistor T4 is larger than or equal to the width of the back channel B2 so as to accurately control ON-OFF switching of the front and back channels F2 and B2.

As shown in FIG. 2, each of the shift registers 21 is adjustable to add a fifth transistor T5, a sixth transistor T6 and a seventh transistor T7 to increase reliability of the circuit. The arrangement thereof is described as follows.

The control electrode of the fifth transistor T5 is electrically connected to the output signal Out(n+2) of the next-stage shift register, and the first electrode of the fifth transistor T5 is electrically connected to the second electrode of the first transistor T1, and the second electrode of the fifth transistor T5 is electrically connected to the a reference voltage VSS. The control electrode of the sixth transistor T6 is electrically connected to the output signal Out(n+2) of the next-stage shift register, and the first electrode of the sixth transistor T6 is electrically connected to the control electrode of the first transistor T1, and the second electrode of the sixth transistor T6 is electrically connected to the a reference voltage VSS. The control electrode and the first electrode of the seventh transistor T7 is electrically connected to a clock signal, and the second electrode of the seventh transistor T7 is electrically connected to the control electrode of the third transistor T3.

The operation of the transistors T1-T7 is described in detail. Upon being triggered by the output signal Out(n−2) from the (N−2)^{th} shift register 21, the second transistor T2 is switched on, and the first transistor T1 outputs an output signal Out(n). Thereafter, upon being triggered by the output signal Out(n+2) from the (N+2)^{th} shift register 21, the sixth transistors T6 is switched on. At this moment, the voltage level of the control electrode of the first transistor T1 equals to the reference voltage VSS, and the first transistor T1 is switched off.

In addition, triggered by a clock signal, the seventh transistor T7 periodically turns on the third transistor T3 and thereby the voltage level of the control electrode of the first transistor T1 is pulled down to the reference voltage VSS. Therefore, the first transistor T1 is able to be maintained at an OFF state before the next output signal Out(n−2) is provided. As the next output signal Out(n−2) is provided, the fourth transistor T4, controlled by voltage level of node P, is switched on, such that the voltage level of the control electrode of the third transistor T3 is pulled down to the reference voltage VSS and thereby the third transistor T3 is switched off. Thus, the first transistor T1 is not constrained by the third transistor T3 and is able to be switched on as normal. The voltage level of node P described above is equal to the voltage level of the second electrode of the second transistor T2.

Due to the arrangement where the shift registers 21 are disposed on the edge area EA of the substrate 11, the shift registers 21 tend to be affected by the voltage of the corresponding color filter, and the back channel of each of the transistors T1-T7 thereof may be unexpectedly switched on which may cause a leakage current problem. To address this problem, the second and fourth transistors T2 and T4 of each of the shift registers 21 are designed to be dual gate transistors. In detail, since the back channel of the second transistor T2 can be maintained at turn off state as the second transistor T2 is switched off, wherein the upper and lower gate electrodes T21 and T22 are at low voltage level Vgl, the leakage current problem would not occur. Additionally, since the front and back channels can be turned on simultaneously as the second transistor T2 is switched on, wherein the upper and lower gate electrodes T21 and T22 are at high voltage level Vgh, the electrical current can be increased. On the other hand, when the fourth transistor is switched off, the lower gate electrode T41 is at low voltage level Vgl, and the upper gate voltage T42 is at reference voltage VSS such that the back channel of the fourth transistor T4 can be kept at an OFF state by the upper gate electrode T42. Through the control of the upper gate electrode, the back channel of the second transistor T2 or the fourth transistor T4 may not be unexpectedly switched on by the voltage of the color filter. Thus, the reliability of the shift register is improved.

The material of the second dielectric layers T27 and T47 of the second and fourth transistors T2 and T4 includes PFA (Polymer Film on Array), SiO2 or SiNx, and the material of the upper gate electrodes T22 and T42 includes ITO (Indium Tin Oxide), IZO (Indium Zinc Oxide), Al, Cu or Mo. A shielding effect can be provided by increasing the thickness of the second dielectric layers T27 and T47. In one embodiment, the thickness of the second dielectric layers T27 and T47 is in a range of 2000-30000 Å. It is appreciated that, although both of the second and the fourth transistors T2 and T4 are dual gate transistors, it should not be limited thereto. In some embodiments, the second transistor is a dual gate transistor while the fourth transistor is a single gate transistor, so that noise can still be reduced. In still some embodiments, the fourth transistor is a dual gate transistor, wherein the second transistor is a dual gate transistor, so that the noise can be further reduced.

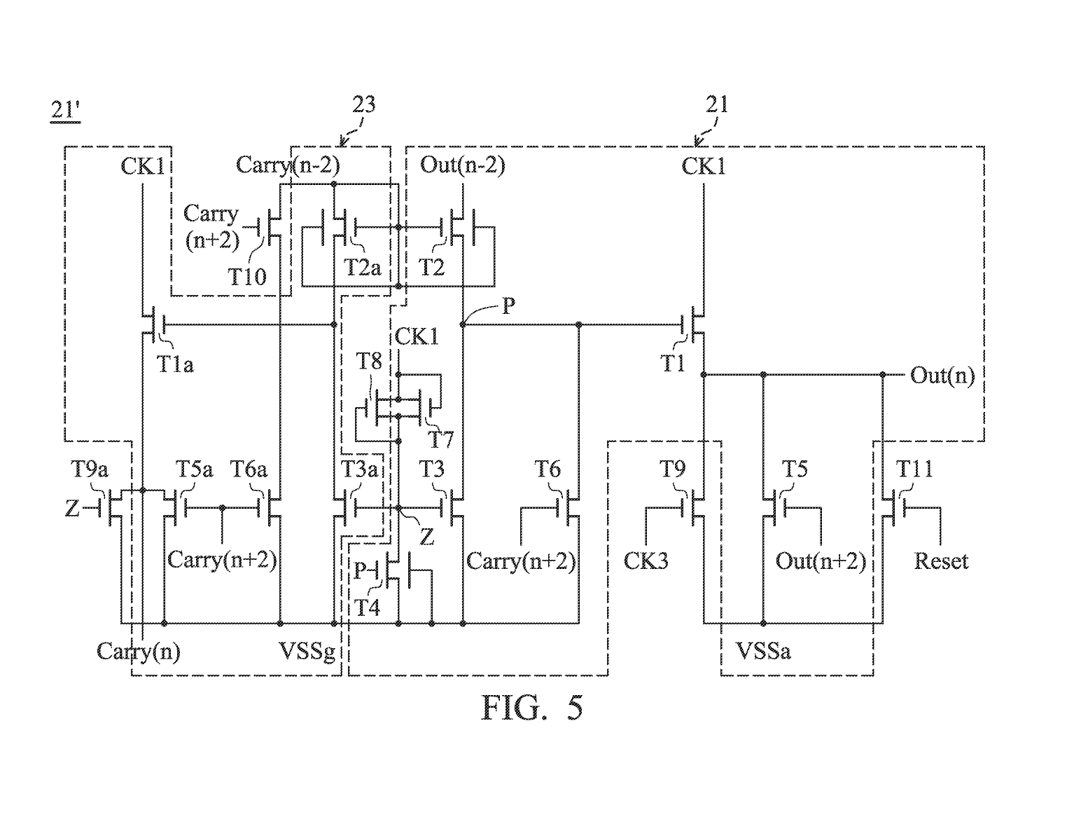

Referring to FIG. 5, the shift register 21′ of another embodiment of the invention includes a shift register 21, a carry unit 23, an eighth transistor T8, two ninth transistors T9 and T9a, a tenth transistor T10 and a eleventh transistor T11. The carry unit 23 is configured to provide an output signal Carry(n) to the next carry unit so as to enhance the power of the signal outputted from the shift register 21′. As shown in FIG. 5, the carry unit 23 includes transistors T1a, T2a, T3a, T5a, and T6a, wherein the interconnection of the transistors T1a, T2a, T3a, T5a, and T6a are similar to that of the transistors T1, T2, T3, T5, and T6 of the shift register 21. It is noted that, the control electrode of the transistor T3a of the carry unit 23 is coupled to the first electrode of the fourth transistor of the shift register 21, and both of the second transistor T2 of the shift register 21 and the second transistor T2 of the carry unit 23 are connected to the pre-stage carry output signal Carry(n−2). In addition, all of the transistors T3 and T3a and the transistor T9a are controlled by the voltage level of node Z.

The eighth transistor T8 is electrically connected to the seventh transistor T7 of the shift register 21 for releasing the stress of the seventh transistor T7. The ninth transistors T9 and T9a are respectively connected to the output end of the shift register 21 and the carry unit 23 for pulling down the noise at the output end. The control electrode of the tenth transistor T10 is electrically connected to the output signal Carry(n+2) from the next-stage carry unit, and the first electrode of the tenth transistor T10 is electrically connected to the output signal Carry(n−2) from the pre-stage carry unit, and the second electrode of the tenth transistor T10 is electrically connected to the control electrode of the first transistor T1a of the carry unit 23. The control electrode of the eleventh transistor T11 is coupled to Reset, to ensure that there is no any noise voltage in the shift register 21′ prior to the starting time of the display.

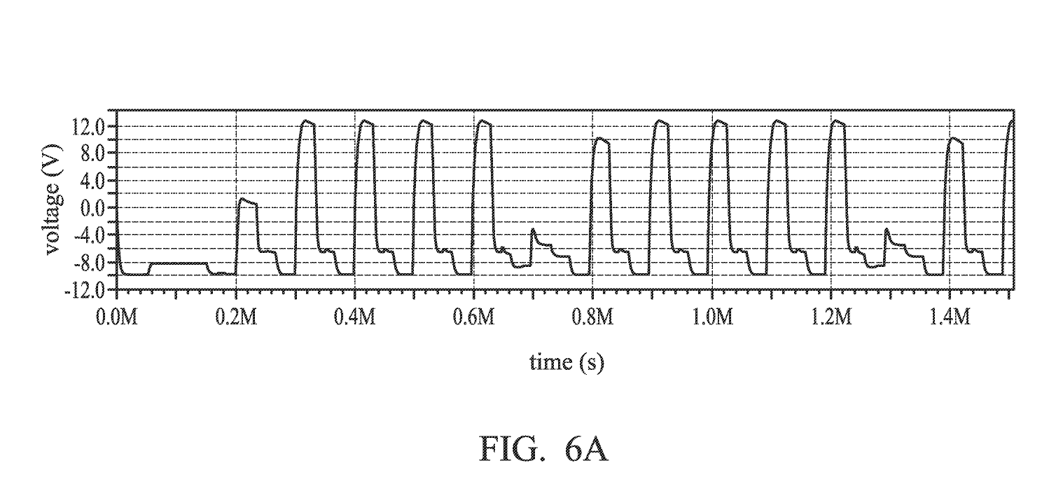

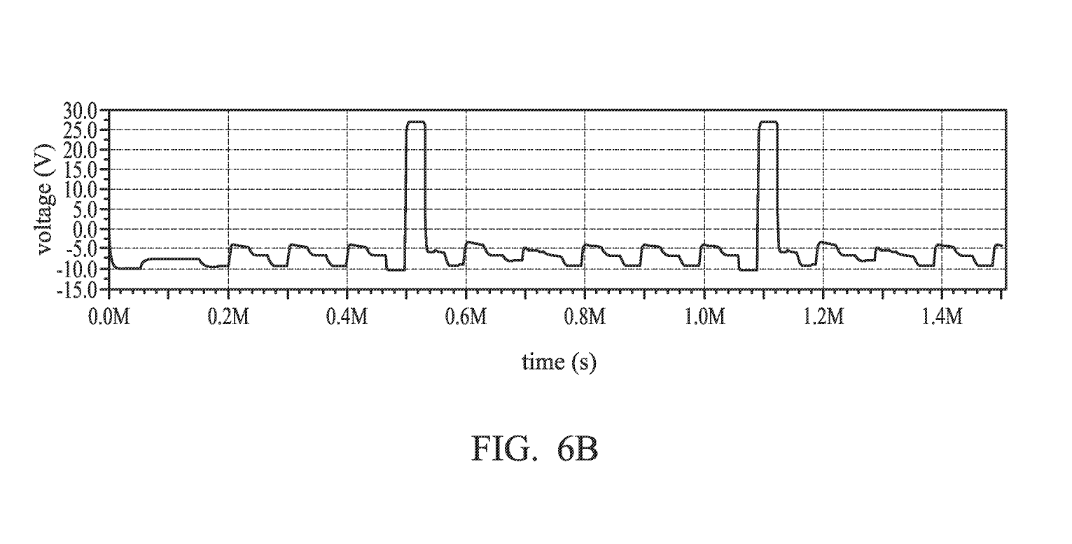

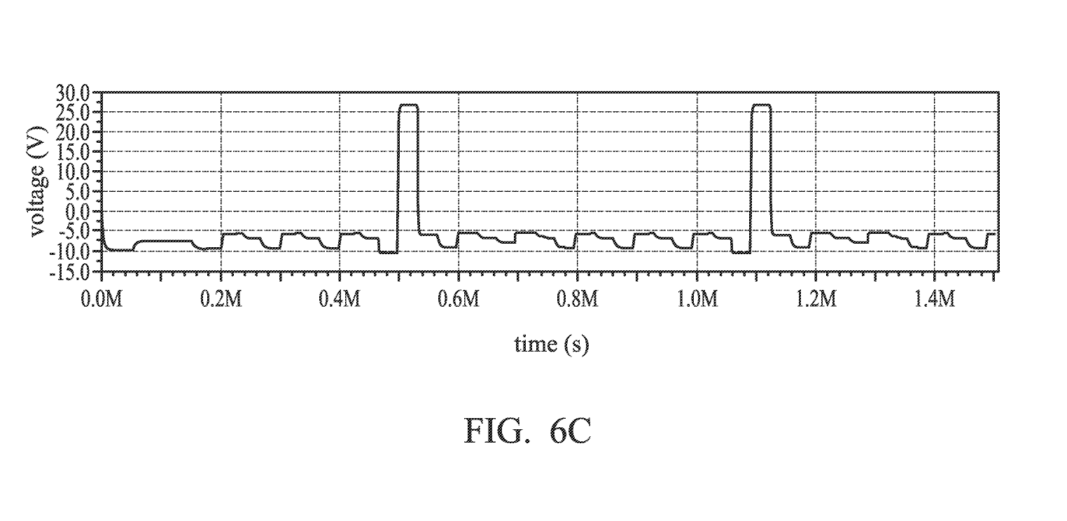

FIG. 6A is a diagram of an output waveform of the circuit layout shown in FIG. 5, wherein the second transistors T2 and T2a and fourth transistor T4 are replaced by single gate transistors. FIG. 6B is a diagram of an output waveform of the circuit layout shown in FIG. 5, wherein the fourth transistor T4 is replaced by a single gate transistor; and FIG. 6C is a diagram of an output waveform of the shift register 21′.

As can be seen from comparison between FIGS. 6A and 6B, the output (FIG. 6B) of the circuit in which the second transistors T2 and T2a are dual gate transistors is more stable than the output (FIG. 6A) of the circuit in which the second transistors T2 and T2a are single gate transistors. Moreover, the output (FIG. 6c) of the circuit in which all of the second transistors T2 and T2a and fourth transistor T4 are dual gate transistors is more stable than the output (FIG. 6A) of the circuit in which the second transistors T2 and T2a are dual gate transistor and the fourth transistor T4 is single gate transistor.

Therefore, in some embodiment, only the second transistors are dual gate transistors while the fourth transistor is a single gate transistor, so that noise can be reduced. In still some embodiments, all of the second and fourth transistors are dual gate transistors to that noise can be further reduced.

According to the above descriptions, the invention overcomes the drawbacks of the conventional shift register through the circuit layout design of the shift register, wherein, in one embodiment, the input unit (second transistor) and the control unit (fourth transistor) are dual gate transistors such that the control accuracy is improved. Thus, a more stable display quality can be achieved with display device of the invention. Additionally, a simplification in manufacturing process is realized, and the cost of production of a duel gate transistor is lowered

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a display panel having an active area and an edge area outside of the active area, the display panel comprising:
a plurality of pixel electrodes, disposed in the active area;
a plurality of scan lines, disposed in the active area and connected to the pixel electrodes; and
a scan driver, disposed in the edge area, comprising a plurality of shift registers, wherein each of the shift registers receives a clock signal from an external circuit, and an output signal from a pre-stage shift register is an input signal of the other shift registers, wherein each of the shift registers comprises:
a first transistor, wherein a first electrode of the first transistor is electrically connected to the clock signal, and a second electrode of the first transistor is electrically connected to the scan lines;
a second transistor, wherein the second transistor is a dual gate transistor, and a control electrode of the second transistor comprises a lower gate electrode and an upper gate electrode, wherein the lower gate electrode of the second transistor is electrically connected to the output signal from the pre-stage shift register, and the upper gate electrode of the second transistor is electrically connected to the lower gate electrode of the second transistor, and a first electrode of the second transistor is electrically connected to the output signal from the pre-stage shift register, and a second electrode of the second transistor is electrically connected to a control electrode of the first transistor;
a third transistor, wherein a first electrode of the third transistor is electrically connected to the control electrode of the first transistor, and a second electrode of the third transistor is electrically connected to a reference voltage; and
a fourth transistor, wherein a first electrode of the fourth transistor is electrically connected to a control electrode of the third transistor, and a second electrode of the fourth transistor is electrically connected to the reference voltage.

2. The display device as claimed in claim 1, wherein the fourth transistor is a dual gate transistor, and a control electrode of the fourth transistor comprises a lower gate electrode and an upper gate electrode, wherein the lower gate electrode of the fourth transistor is electrically connected to the second electrode of the second transistor, and the upper gate electrode of the fourth transistor is electrically connected to the reference voltage or to the lower gate electrode of the fourth transistor.

3. The display device as claimed in claim 1, wherein each of the registers further comprises:
a fifth transistor, wherein a control electrode of the fifth transistor is electrically connected to an output signal of a next-stage shift register, and a first electrode of the fifth transistor is electrically connected to the second electrode of the first transistor, and a second electrode of the fifth transistor is electrically connected to the reference voltage; and
a sixth transistor, wherein a control electrode of the sixth transistor is electrically connected to the output signal of the next-stage shift register, and a first electrode of the sixth transistor is electrically electrode of the sixth transistor is electrically connected to the reference voltage.

4. The display device as claimed in claim 3, wherein each of the registers further comprises:
a seventh transistor, wherein a control electrode and a first electrode of the seventh transistor are electrically connected to the clock signal, and a second electrode of the seventh transistor is electrically connected to the control electrode of the third transistor.

5. The display device as claimed in claim 1, wherein the material of the upper gate electrode of the fourth transistor comprises ITO, IZO, Al, Cu or Mo.

6. The display device as claimed in claim 1, wherein the display panel further comprises a substrate, and the lower gate electrode of the second transistor is formed on the substrate, and the second transistor further comprises:
a first dielectric layer, covering the lower gate electrode of the second transistor and the substrate;
a semiconductor layer, formed on the first dielectric layer, wherein the first and second electrodes of the second transistor are located at two opposite sides of the semiconductor layer; and
a second dielectric layer, covering the first and second electrodes of the second transistor and the semiconductor layer, wherein the upper gate electrode of the second transistor is formed on the second dielectric layer corresponding to the semiconductor layer.

7. The display device as claimed in claim 6, wherein a front channel is defined at one side of the semiconductor layer adjacent to the lower gate electrode of the second transistor, and the width of the upper gate electrode of the second transistor is larger than or equals to the length of the front channel.

8. The display device as claimed in claim 6, wherein a back channel is defined at one side of the semiconductor layer adjacent to the upper gate electrode of the second transistor, and the width of the upper gate electrode of the second transistor is larger than or equals to the length of the back channel.

9. The display device as claimed in claim 6, wherein the thickness of the second dielectric layers is in a range of 2000-30000 Å.

10. The display device as claimed in claim 6, wherein the material of the second dielectric layers of the second transistor comprises a-Si, LTPS, or IGZO.

11. The display device as claimed in claim 6, wherein the semiconductor layer comprises a stop etching layer.
